(19) United States
(12) Patent Application Publication
(10) Pub. No.: US 2024/0286119 A1
(43) Pub. Date: Aug. 29, 2024

(54) NANOCATALYST FOR DRY REFORMING OF METHANE

(71) Applicant: DRM CATALYST INC., Ulsan (KR)

(72) Inventors: Gun-Tae KIM, Ulsan (KR); Jin-Kyung OH, Ulsan (KR); Kyung-Joong YOON, Seoul (KR); Ji -Su SHIN, Seoul (KR)

(73) Assignee: DRM CATALYST INC., Ulsan (KR)

(21) Appl. No.: 18/572,547

(22) PCT Filed: Jun. 28, 2022
(86) PCT No.: PCT/KR2022/009271

§ 371 Date: Dec. 20, 2023

(30) Foreign Application Priority Data
Jul. 1, 2021 (KR) 10-2021-0086382

(51) Int. Cl. B01J 23/83; B01J 35/45; B01J 37/04; B01J 37/08

(52) U.S. Cl. CPC B01J 23/83; B01J 35/45; B01J 37/04; B01J 37/08; B01J 2235/30

(57) ABSTRACT

A nanocatalyst for methane dry reforming has a fluorite structure and has a plurality of transition metal or noble metal particles dispersed on a surface thereof. The nanocatalyst is represented by the Chemical Formula, A₁₋ₐCeₐO_{2-δ}. In the Chemical Formula, A is selected from rare earth elements excluding Ce, and a and δ are real numbers of 0<a<1 and 0≤δ≤1, respectively.

### CROSS-REFERENCE TO PRIOR APPLICATIONS

This application is a National Stage Patent Application of PCT International Application No. PCT/KR2022/009271 (filed on Jun. 28, 2022), which claims priority to Korean Patent Application No. 10-2021-0086382 (filed on Jul. 1, 2021), which are all hereby incorporated by reference in their entirety.

### BACKGROUND

The present invention relates to a nanocatalyst for methane dry reforming.

As greenhouse gas emissions and global warming issues have become a major concern around the world, research on ways to reduce and treat carbon dioxide emissions is actively progressing. A representative chemical method for reducing carbon dioxide is the methane-reforming reaction, which reacts carbon dioxide (CO₂) and methane (CH₄) to generate syngas such as CO and H₂.

As a reforming reaction of methane, dry reforming of methane, unlike wet reforming of methane (steam reforming of methane; reaction of natural gas and water), has the advantage of producing syngas of great industrial value because the H₂/CO ratio is close to 1.

Reaction Equation (1) below represents a dry reforming reaction of methane with carbon dioxide.

CH₄+CO₂→2CO+2H₂ (1)

During dry reforming of methane in Reaction Equation (1), the following side reactions occur together.

CO₂+H₂→CO+H₂O (2)

2CO→C+CO₂ (3)

CO+H₂→C+H₂O (4)

CH₄→C+H₂ (5)

CO₂→C+O₂ (6)

Thermodynamically, the methane dry reforming in Reaction Equation (1) proceeds spontaneously at 640° C. or higher, while the reverse water gas shift reaction in Reaction Equation (2) and the Boudouard reaction in Reaction Equation (3) proceed spontaneously at 815° C. and 710° C. or lower, respectively. Therefore, in order to suppress side reactions and allow the syngas conversion reaction to predominantly occur, a methane dry reforming reaction needs to be performed at a high temperature of 700° C. or higher.

Depending on the reaction conditions, a carbon precipitation reaction as shown in Reaction Equations (3) to (6) may occur, in particular, carbon deposition occurs easily in nickel-based catalysts, leading to rapid deactivation of the catalyst. On the other hand, when using a noble metal catalyst, resistance to carbon deposition increases, but economic feasibility becomes an issue due to the high price. Therefore, in order to commercialize methane dry reforming technology, it is necessary to develop a cost-competitive catalyst that has a high syngas conversion rate and carbon deposition inhibition ability.

As the dispersion of the catalyst formed on the ceramic support increases, the utilization rate of the material increases. In other words, since the thermochemical reaction occurs on the surface of the catalyst, the finer and more uniformly distributed the catalyst is on the surface of the support, the greater the effect may be achieved with a small amount. However, as the size of the catalyst gets smaller, the tendency to agglomerate becomes stronger, which intensifies the problem of thermal stability in a high-temperature reaction. Accordingly, there is a need for a catalyst for methane dry reforming that is stable at high temperature while having catalyst particles finely distributed on the surface of the ceramic support.

### SUMMARY

The present invention is directed to providing a catalyst for methane dry reforming, which has high catalytic activity and is stable for a long time even when operated at high temperature.

According to an aspect of the present invention, there is provided a nanocatalyst for methane dry reforming, which has a fluorite structure represented by the following Chemical Formula 1 and has a plurality of transition metal or noble metal particles dispersed on a surface thereof:

A₁₋ₐCeₐO_{2-δ} [Chemical Formula 1]

in Chemical Formula 1, A is selected from rare earth elements excluding Ce, and a and δ are real numbers of 0<a<1 and 0≤δ≤1, respectively.

A catalyst of the present invention has a high conversion rate because the transition metal or noble metal particles are uniformly distributed on the surface of the catalyst. In addition, since the transition metal or noble metal particles form strong bonds in an ionic state, agglomeration does not occur at high temperatures, and the risk of carbon deposition is significantly low, so excellent conversion rates can be maintained even when used at high temperatures for a long period of time. In addition, the catalyst of the present invention can be prepared by a chemical solution synthesis method that is simple and easy to mass produce. When methane dry reforming is applied to industry in earnest, it is expected to greatly contribute to reducing greenhouse gases and efficiently producing syngas.

### BRIEF DESCRIPTION OF THE DRAWINGS

FIG. 1 is a transmission electron microscope (TEM) image of Pt(4 wt %)/Gd_{0.2}Ce_{0.8}O_{1.9} nanocatalyst particles.

FIG. 2 shows the results of TEM/EDS component analysis of Pt (4 wt %)/GDC particles after heat treatment at 650° C.

FIG. 3 shows the results of HRTEM analysis of Pt (4 wt %)/GDC particles after heat treatment and reduction at 850° C.

FIG. 4 shows the results of XPS analysis of Pt (4 wt %)/GDC particles.

FIGS. 5A and 5B are graphs showing the activities of the Pt (4 wt %)/GDC nanocatalyst according to the present invention and the comparative GDC catalyst in terms of CH₄ conversion rate (%) (FIG. 5A) and CO₂ conversion rate (%) (FIG. 5B).

FIG. 6 shows the results of the long-term stability evaluation of the Pt (4 wt %)/GDC nanocatalyst according to the present invention.

### DETAILED DESCRIPTION

Hereinafter, the present invention will be described in detail.

The terms used in the present application are only used to describe specific embodiments and are not intended to limit the present invention. Unless defined otherwise, all terms used herein, including technical or scientific terms, have the same meaning as commonly understood by one of ordinary skill in the art to which the present invention belongs.

Throughout the specification, when it is said that a part “includes,” “contains,” or “has” a certain component, this means that it may further include other components, unless specifically defined otherwise.

Terms such as first and second are used to distinguish one component from another component, and the components are not limited by the above-mentioned terms.

When a part of a layer, a membrane, and the like is said to be “above’ or “on” another part, this includes not only cases where one part is in contact with another part by being “directly above” or “directly on” another part, but also cases where another part is present in the middle. Conversely, when a part is said to be ‘directly above” or “directly on” another part, it means that there are no other parts therebetween.

The nanocatalyst for methane dry reforming according to the present invention has a fluorite structure represented by the following Chemical Formula 1 and has a plurality of transition metal or noble metal particles dispersed on a surface thereof:

A₁₋ₐCeₐO_{2-δ} [Chemical Formula 1]

in Chemical Formula 1, A is selected from rare earth elements excluding Ce, and a and δ are real numbers of 0<a<1 and 0≤δ≤1, respectively.

According to one embodiment of the present invention, in Chemical Formula 1, A may be selected from the group consisting of Y, Sc, Gd, Sm, La, Nb, Nd, Pr, Yb, Er, and Tb. According to another embodiment of the present invention, in Chemical Formula 1, A may be an element selected from the lanthanide group, for example, Gd, Sm, La, Nb, Nd, Pr, Yb, Er, and Tb.

According to one embodiment of the present invention, in Chemical Formula 1, a may be a real number of 0.5≤a<1, and 6 may be a real number of 0≤δ≤0.5.

According to another embodiment of the present invention, the nanocatalyst for methane dry reforming of the present invention may have a fluorite structure represented by the following Chemical Formula 2 and have a plurality of transition metal or noble metal particles dispersed on the surface thereof:

Gd₁₋ₐCeₐO_{2-δm} [Chemical Formula 2]

in Chemical Formula 1, a and 6 are real numbers of 0<a<1 and 0≤δ≤1, respectively.

According to one embodiment of the present invention, in the nanocatalyst for methane dry reforming of the present invention, the transition metal or noble metal particle may be selected from the group consisting of Pt, Au, Ag, Pd, Ir, Rh, Ru, Pd, Os, Ni, Co, and Fe. For example, the transition metal or noble metal particle may be Pt, Au, Ag, Ni, or Co.

According to one embodiment of the present invention, the transition metal or noble metal particles may be present in an ionic state or in both an ionic and a metallic state. For example, since the transition metal or noble metal particles are present in an ionic state, they may be strongly bonded to the base material of the fluorite structure in a doped form. Accordingly, since they do not easily move even at high temperature, for example, 800° C. or higher, and the particles may maintain a fine and uniform distribution, they may maintain excellent activity for a long period of time without causing agglomeration.

According to one embodiment of the present invention, the transition metal or noble metal particles may form fine particles or atomic clusters on the surface or may be present in a single atomic state. According to one embodiment of the present invention, the transition metal or noble metal particles may have a size of 0.1 to 5 nm, for example, 0.5 to 2.5 nm. Meanwhile, in the case of the nanocatalyst of the present invention, the catalyst particle size may be 5 to 200 nm, for example, 5 to 50 nm.

According to one embodiment of the present invention, the transition metal or noble metal particles may be present in an amount of 0.1 to 10% by weight, for example, 3 to 5% by weight, based on the weight of the nanocatalyst.

According to another embodiment of the present invention, the nanocatalyst may be used at a temperature of 700° C. or higher. As can be seen from the examples described later, when the nanocatalyst according to the present invention is used for dry reforming of methane at a temperature of 700° C. or higher, CH₄ and CO₂ conversion rates of 70% or more may be achieved.

According to one embodiment of the present invention, the nanocatalyst may exhibit a CH₄ conversion rate of 90% or more and a CO₂ conversion rate of 95% or more at a temperature of 800° C. or higher.

The catalyst of the present invention may be prepared by a solution synthesis method and thus it is easy to prepare and may be applied to mass production.

According to one embodiment of the present invention, the nanocatalyst of the present invention may be prepared by a method including (a) mixing a precursor of the fluorite structure material of Chemical Formula 1 and a precursor of the transition metal or noble metal particles as a solution and (b) heat-treating the mixture.

The precursor of the fluorite structure material in step (a) may be, for example, in the form of one or more selected from ceramic nanopowder, chlorides, bromides, iodides, nitrates, nitrites, sulfates, acetates, sulfites, acetylacetonate salts, and hydroxides, but is not limited thereto. Preferably, the precursor may be in the form of a nitrate.

In step (a), the precursor of the transition metal or noble metal particles may be, for example, in the form of one or more selected from metal nanopowder, chlorides, bromides, iodides, nitrates, nitrites, sulfates, acetates, sulfites, acetylacetonate salts, and hydroxides, but is not limited thereto. Preferably the precursor may be in the form of a chloride.

In step (a), water, alcohol, or a mixed solvent of water and alcohol may be used as a solvent in the solution. Here, the alcohol may be appropriately selected from alcohols having 1 to 4 carbon atoms, for example, methanol, ethanol, propanol, or butanol. An amount of solvent may be at a concentration of 0.05 to 1 M. When a mixed solvent of water and alcohol is used as the solvent, a mixing ratio between these solvents may be a volume ratio of 1:0 to 3:1 based on the volume of the total solvent.

In step (a), the solution may further contain a complexing agent in addition to the precursor of the fluorite structure material, the precursor of the transition metal or noble metal particles, and the solvent.

The complexing agent may be, for example, one or more selected from urea, melamine, diethylenetriamine, glycine, ethylenediaminetetraacetic acid, nitrilotriacetic acid, diaminocyclohexane-N,N′-tetra-acetic acid, diethylenetriaminepentaacetic acid, and ethylene glycol-bis-(2-aminoethyl ether), but is not limited thereto. Preferably, urea may be used. In addition, an amount of the complexing agent may be 3 to 15 times that of the cations in the solution.

In step (b), the heat treatment may be performed at 50° C. to 900° C., for example, 300° C. to 900° C. or 600° C. to 900° C. The heat treatment may be divided into two or more steps so that the temperature may be reached in two or more steps, for example, five steps.

Hereinafter, the present invention will be described in more detail with reference to examples of the present invention. Since the examples are presented to explain the present invention, the present invention is not limited thereto.

### [Preparation Example] Preparation of Nanocatalyst According to Present Invention

Ce(NO₃)₃-6H₂O, Gd(NO₃)₃-6H₂O, K₂PtCl₄, and urea were added to distilled water and dissolved using a magnetic stirrer for about 10 minutes. Thereafter, ethanol was added and the solution was mixed using the magnetic stirrer for 10 minutes. At this time, the composition of the solution for synthesizing Pt (4 mol %)-GDC powder is shown in Table 1 below. Thereafter, the solution was heat-treated using an electric furnace according to the heat treatment schedule shown in Table 2 below to obtain Pt (4 mol %)-GDC nanocatalyst powder.

TABLE 1

| Components | Content (g) |
|---|---|
| Cerium nitrate hexahydrate | 0.695 |
| Gadolinium nitrate hexahydrate | 0.181 |
| Potassium tetrachloro-palatinate | 0.032 |
| Urea | 1.247 |
| D.I water | 3 |
| Ethanol | 0.789 |

TABLE 2

| | | Temperature | | Temperature | | Mainte- | |
|---|---|---|---|---|---|---|---|
| | | increase | | increase | | nance | Atmosphere, flow |
| Temperature | | time | | rate | | time | rate |
| 80° | C. | 10 | min | 8° | C./min | 2 hr | Air, 100 cc/min |
| 150° | C. | 2 | hr | 0.58° | C./min | 1 hr | Air, 100 cc/min |
| 300° | C. | 30 | min | 5° | C./min | 1 hr | Air, 100 cc/min |
| 500° | C. | 40 | min | 5° | C./min | 2 hr | Air, 100 cc/min |
| 650° | C. | 30 | min | 5° | C./min | 1 hr | Air, 100 cc/min |
| 850° | C. | 40 | min | 5° | C./min | 1 hr | Hydrogen, 100 |
| | | | | | | | cc/min |
| 20° | C. | 2 | hr | | | 0 | Hydrogen, 100 |
| | | | | | | | cc/min |

### [Evaluation Example 1] Analysis of Particle Properties of Nanocatalyst

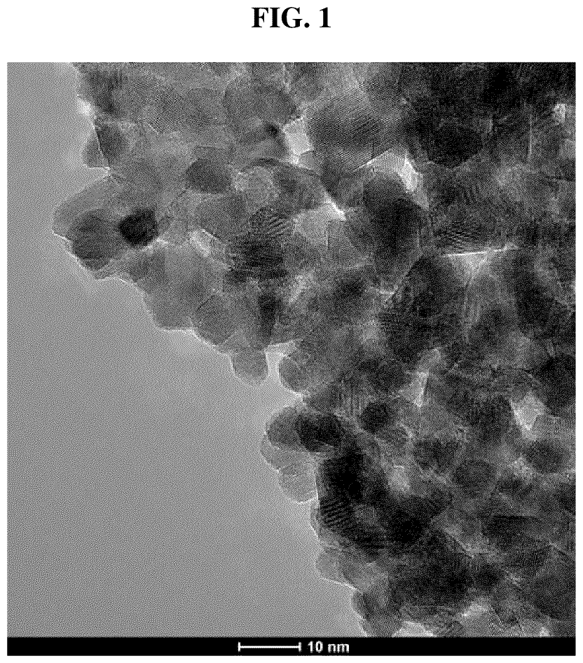

A transmission electron microscope (TEM) image of the Pt(4 wt %)/Gd_{0.2}Ce_{0.8}O_{1.9} (GDC) nanocatalyst particles prepared in the Preparation Example is shown in FIG. 1. It can be confirmed that when the final heat treatment was performed at 650° C., the particle size was about 10 nm.

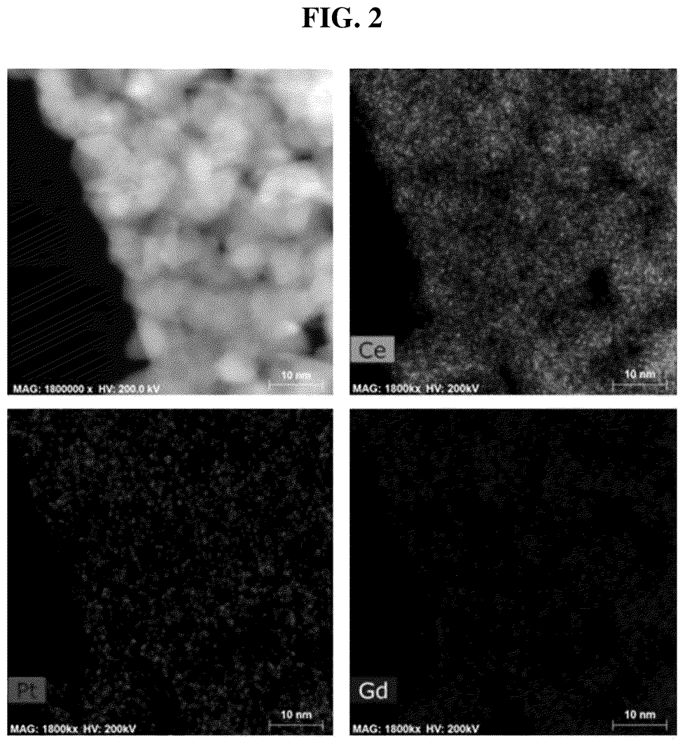

FIG. 2 shows the results of TEM/EDS component analysis of Pt (4 wt %)/GDC particles after heat treatment at 650° C. It can be confirmed that Gd was uniformly doped into the ceria nanoparticles, and Pt was also uniformly distributed throughout the ceria particles on a very fine scale without significant agglomeration.

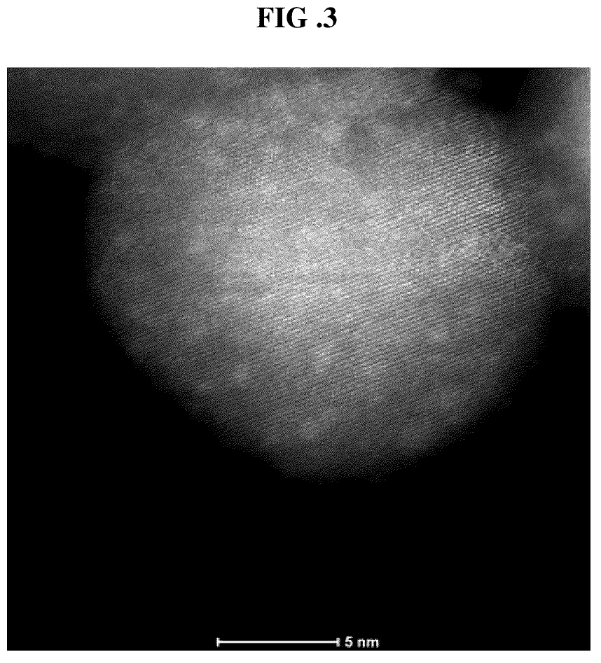

FIG. 3 shows the results of HRTEM analysis of Pt (4 wt %)/GDC particles after heat treatment and reduction at 850° C. Pt (4 wt %)/GDC particles were heat-treated at 850° C. and exposed to a reducing atmosphere of 97% H₂-3% H₂O at the same temperature, and then the distribution of Pt was observed using HRTEM. Most of the Pt formed fine particles or atomic clusters of 1 to 2 nm or less, and Pt in a single atomic state was also observed. Therefore, it can be seen that Pt distributed on the surface of ceria nanoparticles has excellent thermal stability even at very high temperatures and does not significantly agglomerate even when exposed to a high temperature reducing atmosphere.

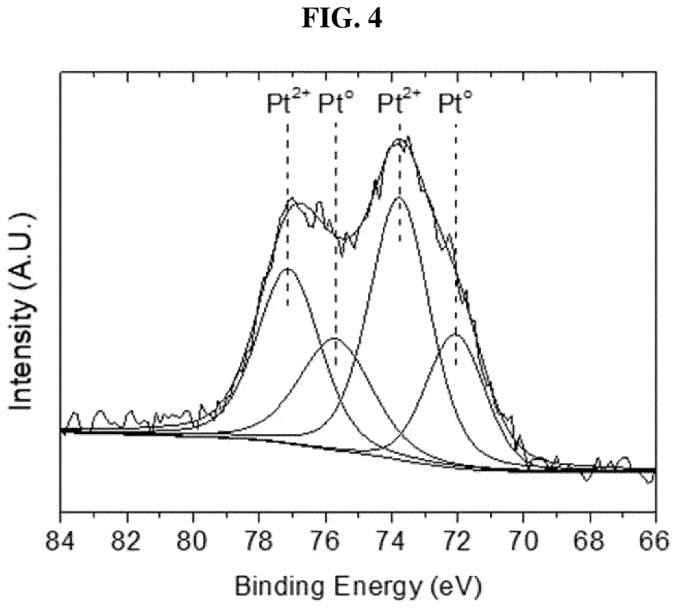

FIG. 4 shows the results of XPS analysis of Pt (4 wt %)/GDC particles. XPS analysis shows that some Pt is present in a metallic state, but a significant amount is present as divalent ions rather than in metallic form. Generally, when Pt metal nanoparticles are exposed to high temperatures, they quickly aggregate, but a significant amount of the Pt of the present invention is in an ionic state, and since it is strongly bonded to ceria in a doped form, it is thought to be able to maintain a fine and uniform distribution without easily moving even at a high temperature of 850° C.

### [Evaluation Example 2] Evaluation of Catalytic Activity of Nanocatalyst

The methane dry reforming characteristics of the Pt (4 wt %)/GDC catalyst were evaluated. The reactor size was a ½ inch tube and 0.2 g of catalyst was used. A composition ratio of the input gas was CH₄:CO₂:He=1:1.12:0.96, and the evaluation was performed under the condition of WHSV 30,000 cc/g h.

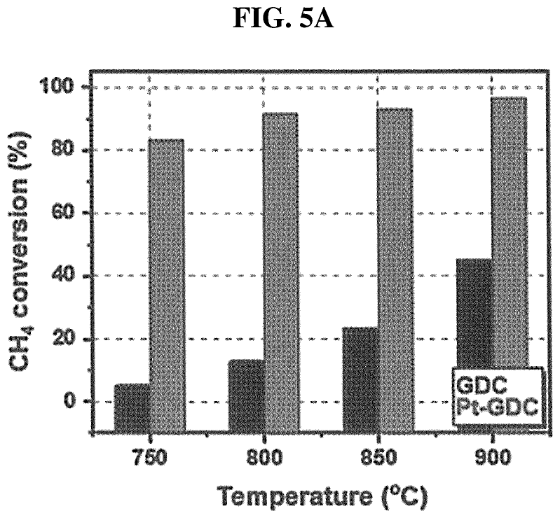

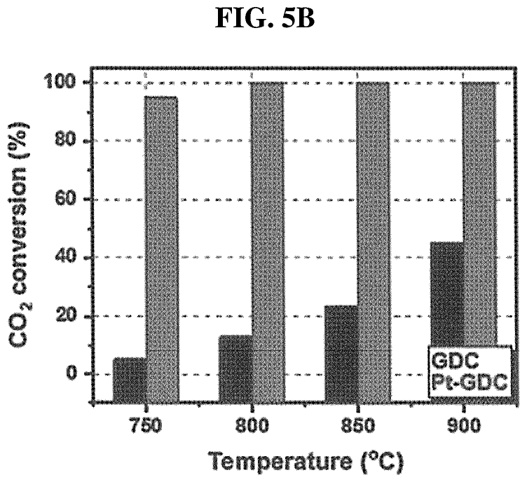

FIG. 5 shows CH₄ and CO₂ conversion rates in a temperature range of 750 to 900° C. The CH₄ conversion rate was 90% or more at 800° C. or higher, and the CO₂ conversion rate was close to 100% at 800° C. or higher.

FIG. 5 also shows a comparison of the CH₄ and CO₂ conversion rates of GDC catalysts of the same composition without Pt added. In the absence of Pt, GDC alone shows CH₄ and CO₂ conversion rates of 20% or less at 800° C., confirming that Pt plays a critical role in the dry reforming reaction of methane.

### [Evaluation Example 3] Evaluation of Stability of Nanocatalyst

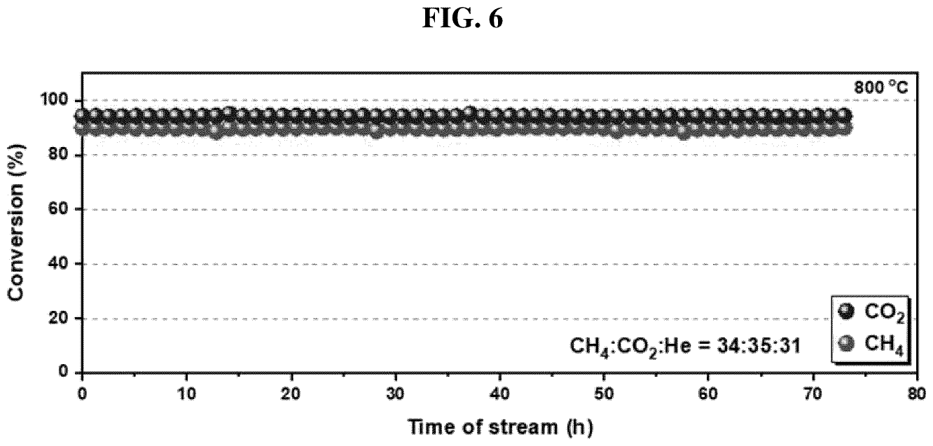

The long-term stability of the Pt (4 wt %)/GDC catalyst was evaluated at 800° C. FIG. 6 graphically shows the results of the long-term stability evaluation of the catalyst. As shown in FIG. 6, the nanocatalyst according to the present invention operated stably without decreasing the CH₄ and CO₂ conversion rates for 70 hours or more. In other words, it can be confirmed that Pt did not aggregate and maintained a stable state even under dry reforming reaction conditions of methane.

Although the present invention has been described above with reference to the preferred embodiments, a person having ordinary skill in the art can understand that various modifications and changes of the present invention are possible within the spirit and scope of the present invention set forth in the following patent claims.

1. A nanocatalyst for methane dry reforming, which has a fluorite structure represented by the following Chemical Formula 1 and has a plurality of transition metal or noble metal particles dispersed on a surface thereof:
A₁₋ₐCeₐO_{2-δ} [Chemical Formula 1]
in Chemical Formula 1, A is selected from rare earth elements excluding Ce, and a and 6 are real numbers of 0<a<1 and 0≤δ≤1, respectively.

2. The nanocatalyst of claim 1, wherein in Chemical Formula 1, A is selected from the group consisting of Y, Sc, Gd, Sm, La, Nb, Nd, Pr, Yb, Er, and Tb.

3. The nanocatalyst of claim 1, wherein in Chemical Formula 1, a is a real number of 0.5≤a<1 and δ is a real number of 0≤δ≤0.5.

4. The nanocatalyst of claim 1, wherein the transition metal or noble metal particle is selected from the group consisting of Pt, Au, Ag, Pd, Ir, Rh, Ru, Pd, Os, Ni, Co, and Fe.

5. The nanocatalyst of claim 1, wherein the transition metal or noble metal particles are present in an ionic state or in both an ionic and a metallic state.

6. The nanocatalyst of claim 1, wherein the transition metal or noble metal particles are present in an amount of 0.1 to 10% by weight based on the weight of the nanocatalyst.

7. The nanocatalyst of claim 1, wherein the transition metal or noble metal particle has a size of 0.1 to 5 nm.

8. The nanocatalyst of claim 1, wherein the nanocatalyst has a catalyst particle size of 5 to 200 nm.

9. The nanocatalyst of claim 1, wherein the nanocatalyst is used at a temperature of 700° C. or higher.

10. The nanocatalyst of claim 9, wherein the nanocatalyst exhibits a CH₄ conversion rate of 90% or more and a CO₂ conversion rate of 95% or more at a temperature of 800° C. or higher.

11. The nanocatalyst of claim 1, wherein the nanocatalyst is prepared by a method comprising mixing a precursor of the fluorite structure material of Chemical Formula 1 and a precursor of the transition metal or noble metal particle as a solution and heat-treating the mixture.

12. The nanocatalyst of claim 11, wherein the heat treatment is performed at 300° C. to 900° C.
